(19) United States
(12) Patent Application Publication
(10) Pub. No.: US 2018/0102520 A1
(43) Pub. Date: Apr. 12, 2018

(54) POWER SUPPLY SYSTEM

(71) Applicant: Dr. Ing. h.c. F. Porsche Aktiengesellschaft, Stuttgart (DE)

(72) Inventor: Bernhard Nekum, Sachsenheim (DE)

(73) Assignee: Dr. Ing. h.c. F. Porsche Aktiengesellschaft, Stuttgart (DE)

(21) Appl. No.: 15/729,089

(22) Filed: Oct. 10, 2017

(30) Foreign Application Priority Data
Oct. 11, 2016 (DE) 102016119270.8

(51) Int. Cl. H01M 2/10; H01M 2/02

(52) U.S. Cl. CPC H01M 2/1094; H01M 2220/20; H01M 2/0237

(57) ABSTRACT

A power supply system for a motor vehicle includes an electric power supply and a fluid storage, wherein the fluid storage has a housing and a fluid storage space, in which a fluid can be stored, wherein the housing surrounds the fluid storage space, wherein the fluid storage is arranged adjacent to the power supply, and wherein the housing is of reinforced design.

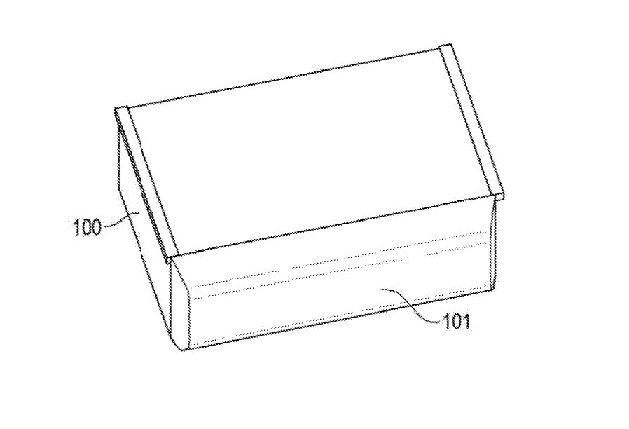

### CROSS-REFERENCE TO RELATED APPLICATIONS

This application claims priority to German Patent Application No. DE 10 2016 119 270.8, filed Oct. 11, 2016, the content of such application being incorporated by reference herein in its entirety.

### FIELD OF THE INVENTION

The invention relates to a power supply system for a motor vehicle comprising an electric power supply means and a fluid storage means.

### BACKGROUND OF THE INVENTION

Motor vehicles having a hybrid drive comprise an electric power supply means, e.g. a storage battery, which should be protected from the effects of forces in an accident.

DE 10 2013 110 468 A1, which is incorporated by reference herein, discloses an impact element for a motor vehicle having a flat main body, which is formed from a rigid material and, on one side, has connecting sections for fixing the main body on a supporting frame of the motor vehicle. Here, the main body has a gastight chamber, in which at least one opening is formed in order to fill the chamber with compressed air.

DE 10 2014 008 480 A1, which is incorporated by reference herein, discloses a subassembly comprising a battery and a gas reservoir. The gas reservoir protects the battery from the effects of external forces as a mounted-on guard.

DE 10 2008 036 626 A1, which is incorporated by reference herein, discloses a gastight and/or liquid-tight container which is provided on a motor vehicle and which forms one region of a structural component of the motor vehicle.

Given the above, it would be desirable to provide a reliable and space-saving power supply system. Moreover, the intention is to provide a motor vehicle that has a power supply system of this kind.

### SUMMARY OF THE INVENTION

The power supply system comprises an electric power supply means and a fluid storage means. The electric power supply means can be a storage battery of a hybrid drive of the motor vehicle, for example. The fluid storage means has a housing and a fluid storage space, in which a fluid can be stored. The housing surrounds the fluid storage space. The fluid storage means is arranged adjacent to the power supply means. In the context of this description, this is taken to mean, in particular, that no components are arranged between a cover of the power supply means and the fluid storage means. On the other hand, it is possible for an air gap to be arranged between a cover of the power supply means and the fluid storage means.

Moreover, it is envisaged that the housing is of reinforced design. A reinforced design of the housing is taken to mean, in particular, that the housing is designed to be deformed only slightly or not at all when acted upon by forces—e.g. owing to a motor vehicle accident. The fluid storage means having the reinforced housing thus differs from the impact element known from DE 10 2013 110 468 A1, which is incorporated by reference herein, particularly in that the housing is not designed to absorb energy in an accident by deformation but to protect the power supply means by high stiffness.

Thus, the fluid storage means can be used both to protect the power supply means and as a fluid reservoir, thereby saving installation space.

Compared with an unreinforced housing, the reinforced housing has the advantage that the power supply means is particularly well protected from forces that occur. The reinforcement can be achieved, for example, through the choice of material, the thickness of the material and/or reinforcing elements, such as beads, ribs and/or projections.

The arrangement of the fluid storage means adjacent to the power supply means has the advantage, in particular, that the power supply means is particularly well protected from the effects of forces. It is also possible for the housing of the fluid storage means to be part of a frame for the power supply means, said frame being secured on a cover of the power supply means.

According to one embodiment of the invention, the housing can be designed as a closed profile. This embodiment is particularly advantageous for protecting the power supply means from the effects of forces and for the use of the fluid storage space for storing a fluid.

According to one embodiment of the invention, the fluid storage means can comprise sealing elements, which seal off the housing from an environment. This is particularly advantageous for preventing the fluid from escaping from the fluid storage space.

According to one embodiment of the invention, the fluid storage means can be designed as a compressed air reservoir. In this case, the stored compressed air can be used, for example, for an air spring means present in the motor vehicle (e.g. In the region of the running gear).

According to one embodiment of the invention, the housing can have reinforcing elements. The reinforcing elements can comprise beads, ribs and/or projections, for example.

According to one embodiment of the invention, the motor vehicle comprises an air spring means. In this case, the fluid storage means can be a compressed air reservoir for the air spring means. This saves installation space since the fluid storage means can be used both as a compressed air reservoir and as a guard for the power supply means.

According to one embodiment of the invention, the fluid storage means can be designed to protect the power supply means from forces arising due to a frontal or lateral collision of the motor vehicle with some other object. This can be achieved, in particular, by suitable arrangement of the fluid storage means. If the fluid storage means is arranged in front of the power supply means in the direction of travel, for example, the power supply means is particularly well protected from the effects of forces in a frontal collision. If the fluid storage means is arranged laterally, the power supply means is particularly well protected from the effects of forces in a lateral collision.

### BRIEF DESCRIPTION OF THE DRAWINGS

Further features and advantages of the present invention will become clear from the following description of a preferred illustrative embodiment with reference to the attached drawing. Here, the same reference signs are used for identical or similar components and for components with identical or similar functions.

The FIGURE shows a schematic perspective view of a power supply system according to one embodiment of the invention.

### DETAILED DESCRIPTION OF THE INVENTION

The power supply system comprises a storage battery 100 as an electric power supply means and a compressed air reservoir 101 as a fluid storage means. The compressed air reservoir 101 is secured on a cover of the storage battery 100 and is arranged adjacent to the storage battery 100.

The compressed air reservoir 101 has a compressed air storage space surrounded by a housing. The housing is of reinforced design. It consists of a closed profile. The reinforcement is achieved through the choice of material and a suitable material thickness. Moreover, the housing can have reinforcing ribs or reinforcing beads.

The power supply system can be installed in a motor vehicle, allowing the storage battery 100 to be used as a power source for a hybrid drive. The compressed air reservoir 101 can be used as a compressed air source for an air spring means in the motor vehicle. In this way, the compressed air reservoir 101 performs two functions. On the one hand, it protects the storage battery 100 from the effects of forces by virtue of the reinforced design. On the other hand, it can store compressed air for the air spring means. Thus, the installation space required for performing these functions is reduced.

The power supply system can be installed in a motor vehicle in such a way, for example, that the compressed air reservoir 101 is arranged in front of the storage battery 100 in the direction of travel. In this case, the storage battery 101 is protected from the effects of forces by the compressed air reservoir 101 in a frontal collision of the motor vehicle with some other object.

What is claimed is:

1. A power supply system for a motor vehicle, comprising an electric power supply means and a fluid storage means, wherein the fluid storage means has a housing and a fluid storage space in which a fluid can be stored, wherein the housing surrounds the fluid storage space, wherein the fluid storage means is arranged adjacent to the power supply means, and wherein the housing is of reinforced design.

2. The power supply system as claimed in claim 1, wherein the housing is closed.

3. The power supply system as claimed in claim 1, wherein the fluid storage means comprises sealing elements, which seal off the housing from an environment.

4. The power supply system as claimed in claim 1, wherein the fluid storage means is a compressed air reservoir.

5. The power supply system as claimed in claim 1, wherein the housing has reinforcing elements.

6. A motor vehicle comprising the power supply system as claimed in claim 1.

7. The motor vehicle as claimed in claim 6, wherein the motor vehicle comprises an air spring means, and in that the fluid storage means is a compressed air reservoir for the air spring means.

8. The motor vehicle as claimed in claim 6, wherein the fluid storage means is configured to protect the power supply means from forces arising due to a frontal or lateral collision of the motor vehicle with some other object.
